(19) United States
(12) Patent Application Publication
(10) Pub. No.: US 2013/0132582 A1
(43) Pub. Date: May 23, 2013

(54) APPARATUS AND METHOD FOR SUPPORTING QOS IN MIDDLEWARE FOR DATA DISTRIBUTION SERVICE

(71) Applicants: Yong-Yeon KIM, Daejeon (KR); Soo-Hyung LEE, Daejeon (KR); Hyung-Kook JUN, Seoul (KR); Kyung-II KIM, Daejeon (KR); Kyeong-Tae KIM, Daejeon (KR); Jae-Hyuk KIM, Gunpo-si (KR); Won-Tae KIM, Asan-si (KR); Seung-Min PARK, Daejeon (KR)

(72) Inventors: Yong-Yeon KIM, Daejeon (KR); Soo-Hyung LEE, Daejeon (KR); Hyung-Kook JUN, Seoul (KR); Kyung-II KIM, Daejeon (KR); Kyeong-Tae KIM, Daejeon (KR); Jae-Hyuk KIM, Gunpo-si (KR); Won-Tae KIM, Asan-si (KR); Seung-Min PARK, Daejeon (KR)

(73) Assignee: Electronics and Telecommunications Research Institute, Daejeon (KR)

(21) Appl. No.: 13/474,212

(22) Filed: May 17, 2012

(30) Foreign Application Priority Data
Nov. 18, 2011 (KR) 10-2011-0121167

(51) Int. Cl. G06F 15/173

(52) U.S. Cl. 709/226; 709/223

(57) ABSTRACT

Disclosed herein are an apparatus and method for supporting Quality of Service (QoS) in middleware for Data Distribution Service (DDS). The apparatus includes a QoS policy analysis module, a QoS policy management module, and a QoS policy process module. The QoS policy analysis module extracts a set of QoS policies set up by Data Centric Publish Subscribe (DCPS) and associated with publication/subscription, and analyzes the QoS policies. The QoS policy management module determines the consistency of QoS policies of the DDS, and negotiates QoS policies for DDS communication. The QoS policy process module handles the QoS policies of the DDS.

### CROSS-REFERENCE TO RELATED APPLICATION

This application claims the benefit of Korean Patent Application No. 10-2011-0121167, filed on Nov. 18, 2011, which is hereby incorporated by reference in its entirety into this application.

### BACKGROUND OF THE INVENTION

1. Technical Field

The present invention relates generally to an apparatus and method for supporting Quality Of Service (QoS) in middleware for Data Distribution Service (DDS) and, more particularly, to an apparatus and method for supporting QoS in middleware for DDS, which, in order to efficiently support QoS in the middleware for DDS, can modularize base tasks for the functions of various QoS policies and the handling of the QoS policies and can systematically provide QoS in light of the correlations between QoS policy modules.

2. Description of the Related Art

In a ubiquitous environment, a plurality of devices frequently forms one network domain and also exchanges data while dynamically operating in conjunction with each other. In this environment, the technique of equal N:N communication between devices participating in a domain is more efficient than a server/client communication technique using a central server. Object Management Group (OMG) proposed Data Distribution Service (DDS), which is standard communication middleware that provides efficient data distribution using a publish/subscribe communication technique in an environment in which a network domain is dynamically formed and devices can freely participate and leave. When DDS is employed, a weather information management service system, a traffic network management service system and a battle management system which are performed by the cooperation between a plurality of devices may be efficiently designed, implemented, and operated.

Korean Unexamined Patent Application Publication No. 2011-0014943 discloses a network manager, a network management method for a management object and an overlay network, and a QoS providing technology for an overlay network.

However, a conventional DDS system, such as that disclosed in Korean Unexamined Patent Application Publication No. 2011-0014943, is problematic in that technical modification, such as the modification of an algorithm for QoS functionality, or policy modification, such as the modification of a QoS procedure, is difficult because numerous correlations between QoS functions, such as conflicts and dependencies between QoS functions, are not sufficiently taken into account in spite of the presence of the numerous correlations and a base task for adding a QoS function is not present.

There is a need to propose a framework for QoS because no established technology regarding how to set up and apply QoS policies has been proposed.

### SUMMARY OF THE INVENTION

Accordingly, the present invention has been made keeping in mind the above problems occurring in the prior art, and an object of the present invention is to provide an apparatus and method for supporting QoS in middleware for DDS, which, in order to efficiently support QoS in the middleware for DDS, can modularize base tasks for the functions of various QoS policies and the handling of the QoS policies and can systematically provide QoS in light of the correlations between QoS policy modules.

Another object of the present invention is to provide a QoS framework which can easily set up QoS policies in conformity with various purposes.

In order to accomplish the above objects, the present invention provides an apparatus for supporting Quality of Service (QoS) in middleware for Data Distribution Service (DDS), the apparatus including a QoS policy analysis module for extracting a set of QoS policies set up by Data Centric Publish Subscribe (DCPS) and associated with publication/subscription, and analyzing the QoS policies; a QoS policy management module for determining consistency of QoS policies of the DDS, and negotiating QoS policies for DDS communication; and a QoS policy process module for handling the QoS policies of the DDS.

The QoS policy management module may include a QoS policy consistency check module for determining the consistency of the QoS policies by determining suitability of QoS attribute values of the QoS policies set up by a publisher and a subscriber.

The QoS policy management module may include a QoS policy negotiation module for comparing QoS attribute values of the QoS policies exchanged between a publisher and a subscriber and performing negotiation so that the DDS communication is possible.

The QoS policy management module may include a QoS policy scheduling module for distributing QoS policies provided by DDS middleware based on functions of data handling, resource allocation and traffic handling and setting order of priority for the QoS policies.

The QoS policy process module may include a data handling module for handling QoS policies related to data in the DDS.

The QoS policy process module may include a resource allocation module for handling QoS policies related to resources in the DDS.

The QoS policy process module may include a traffic handling module for handling QoS policies related to communication and a network in the DDS.

In order to accomplish the above objects, the present invention provides a method of supporting QoS in middleware for DDS, the method including, by a QoS policy analysis module, extracting a set of QoS policies set up by DCPS and associated with publication/subscription, and analyzing the QoS policies; by a QoS policy management module, determining consistency of the QoS policies of the DDS, and negotiating QoS policies for DDS communication; and by a QoS policy process module, handling the QoS policies of the DDS.

The determining consistency of the QoS policies of the DDS and the negotiating QoS policies may include determining the consistency of the QoS policies by determining suitability of QoS attribute values of the QoS policies set up by a publisher and a subscriber.

The determining consistency of the QoS policies of the DDS and the negotiating QoS policies may include comparing QoS attribute values of the QoS policies exchanged between a publisher and a subscriber, and performing negotiation so that the DDS communication is possible.

The determining consistency of the QoS policies of the DDS and the negotiating QoS policies may include distributing the QoS policies provided by DDS middleware based on functions of data handling, resource allocation and traffic handling, and setting order of priority for the QoS policies.

The handling the QoS policies of the DDS may include handling QoS policies related to data in the DDS.

The handling the QoS policies of the DDS may include handling QoS policies related to resources in the DDS.

The handling the QoS policies of the DDS may include handling QoS policies related to communication and a network in the DDS.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing the structure of DDS for performing the exchange of data via data publisher/subscriber;

FIG. 2 is a block diagram showing the construction of an apparatus for supporting QoS in middleware for DDS according to the present invention;

FIG. 3 is a flowchart illustrating a method of supporting QoS in middleware for DDS according to the present invention;

FIG. 4 is a diagram schematically showing a process of checking the consistency of QoS policies in the method of supporting QoS in middleware for DDS according to the present invention; and

FIG. 5 is a diagram schematically showing a QoS policy negotiation procedure in the method of supporting QoS in middleware for DDS according to the present invention.

### DESCRIPTION OF THE PREFERRED EMBODIMENTS

Reference now should be made to the drawings, via out which the same reference numerals are used to designate the same or similar components.

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

In general, an application program is dependent upon a communication protocol which is suitable for a network and a service environment. The problem that an application program is dependent upon a communication protocol may be solved using middleware performing an agency communication function between an application layer and an operating system layer.

Data Distribution Service (DDS) was defined by OMG for the purpose of data-centric real-time data distribution. DDS enables data to be published to and subscribed by a number of unspecified participants over a network.

If participants within a network frequently exchange data of the same type, a data-centric communication technique is appropriate. Furthermore, when the number of participants participating in a network is large and registration and release are dynamically performed, the exchange of data using a method in which an application program publishes/subscribes desired data without being aware of a counterpart is more effective than the exchange of data using a server/client method in which an application program finds a counterpart with which data will be exchanged and sets up a connection with the counterpart. Publishers who publish data and subscribers who subscribe to data gather, set up a single domain, and distribute data samples of an agreed type in a multicast manner.

Accordingly, when efficient and rapid data distribution is performed using multicast and broadcast mechanisms in DDS, a number of participants of the network domain are classified into publishers who provide data and subscribers who subscribe to the data based on their roles and only participants having the same topic communicate with each other. When the participants exchange data by using the topic, the topic is the type of data which are exchanged by the publishers and the subscribers within the domain, and is defined and used in various ways according to a data message standard in compliance with the purposes of data-centric real-time data distribution.

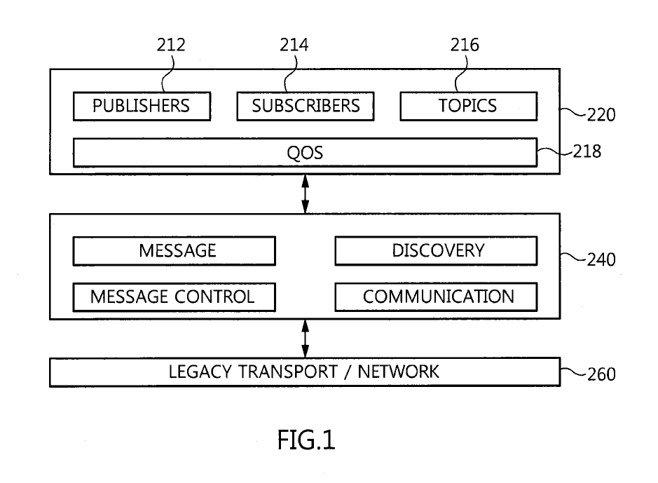

Referring to the structure of DDS schematically shown in FIG. 1 and defined by OMG, the structure of DDS includes a Data Centric Publish-Subscribe (DCPS) 220, and a Real-Time Publish-Subscribe (RTPS) 240 for implementing QoS of data communication.

The DCPS 220 is a functional interface layer for data publication/subscription which is provided to an application program. The application program may perform to publish/subscribe of desirable data through the DCPS 220 without recognition about other participants to exchange data.

The RTPS 240 is a layer for actual data to be published/subscribed. Here, the network 260 may determine the type of data to be exchanged, dynamically discover other participants to exchange data, and deliver and receive data to and from discovered participants through the RTPS 240.

In relation to QoS 218 which is one of the main features provided by the DDS, the QoS 218 is collecting features about the activities of DDS services, and provides different QoS policies to publishers 212, subscribers 214, and topics 216. Here, the DDS provides a total of 22 QoS policies. The 22 QoS policies are listed in Table 1 below:

TABLE 1
QoS Policies

| Durability | User Data | Ownership | Reliability |
|---|---|---|---|
| History | Topic Data | Ownership Strength | Time Based |
| | | | Filter |
| Reader Data | Group data | Liveliness | Deadline |
| Lifecycle | | | |
| Writer Data | Partition | Latency Budget | Content Filters |
| Lifecycle | | | |
| Lifespan | Presentation | Transport Priority | |
| Entity Factory | Destination Order | Resource Limits | |

The QoS policies listed in Table 1 will now be schematically described. First, “Durability” is a policy for the durability of data, and “User Data,” “Topic Data” and “Group Data” are policies for allowing additional information to be attached to data or a topic, a publisher and a subscriber. “Partition” is a policy for a logical communication channel, and “Destination Order” is a policy for the arrangement of data. “Ownership” and “Ownership Strength” are policies indicating weights of data, and “Presentation” is a policy for providing notification of changes. “Destination Order” is a policy for the arrangement of data, and “Resource Limits” and “History” are policies for storing data. “Lifespan” is a policy for the valid period of data, and “Reader Data Lifecycles” and “Writer Data Lifecycle” are policies for the lifespan of a publisher and a subscriber. “Content Filters” is a policy for data filtering based on content, and “Deadline” is a policy for a data transfer period. “Liveliness” is a policy for providing notification that a publisher and a subscriber are alive, and “Latency Budget” is a policy for guaranteeing a maximum communication delay time. “Transport Priority” is a policy for data communication based on the order of priority, “Time Based Filter” is a policy for data filtering based on time, and “Reliability” is a policy for guaranteeing the reliability of data communication.

The policies may be classified based on their functions, as follows. First, “Partition,” “Destination Order,” “Ownership,” “Ownership Strength,” “Presentation” and “Destination Order” correspond to QoS policies for handling data in DDS. Second, “Resource Limits,” “History,” “Durability,” “Lifespan,” “Reader Data Lifecycle,” “Writer Data Lifecycle,” “Content Filters,” “User Data,” “Topic Data” and “Group Data” correspond to QoS policies for handling resources in DDS. Third, “Deadline,” “Liveliness,” “Latency Budget,” “Transport Priority,” “Time Based Filter” and “Reliability” correspond to QoS policies which are associated with communication and a network.

The construction and operation of an apparatus for supporting QoS in middleware for DDS according to the present invention will be described below.

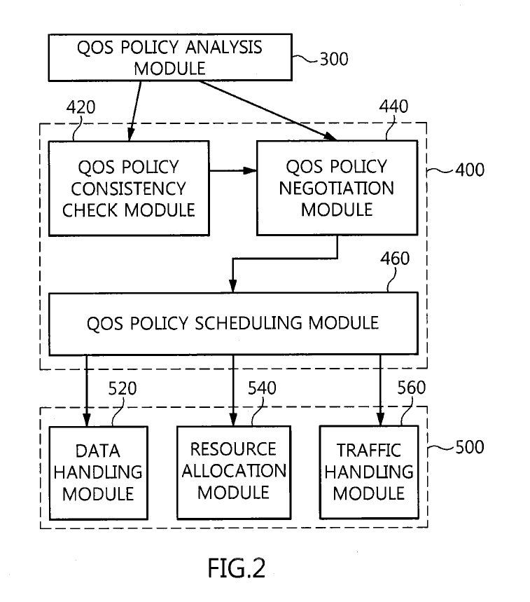

FIG. 2 is a block diagram showing the construction of the apparatus for supporting QoS in middleware for DDS according to the present invention.

Referring to FIG. 2, the apparatus for supporting QoS in middleware for DDS according to the present invention includes a QoS policy analysis module 300, a QoS policy management module 400, and a QoS policy process module 500. The QoS policy management module 400 includes a QoS policy consistency check module 420, a QoS policy negotiation module 440, and a QoS policy scheduling module 460. The QoS policy process module 500 includes a data handling module 520, a resource allocation module 540, and a traffic handling module 560.

The QoS policy analysis module 300 is responsible for the function of analyzing a QoS policy. The QoS policy analysis module 300 reads a set of QoS policies set up by the DCPS 220 of FIG. 1, and analyzes each of the QoS policies. The analysis of QoS policies includes the analysis of QoS policies used in DDS and the analysis of 22 types of QoS policies for a QoS group for each of topics, each of participants, each of publishers/subscribers, and each of data read/writing entities. That is, when an application program user sets up a QoS policy used in DDS in the DCPS 220, the QoS policy analysis module 300 extracts and analyzes the set QoS policy and assigns the attribute value of the QoS policy to each of participants, each of publishers/subscribers, and each of data read/writing entities in DDS.

The QoS policy management module 400 determines the consistency of the QoS policies of DDS and checks negotiations for the communication of DDS.

More specifically, the QoS policy consistency check module 420 is responsible for the function of determining the consistency of QoS policies. The QoS policy consistency check module 420 determines whether the attribute values of QoS policies set up by a publisher and a subscriber are valid. The consistency of QoS policies means the consistency of the attribute values of redundant QoS policies set up for a topic and by a publisher and a subscriber. For example, a QoS policy set up for a topic has higher priority than QoS policies set up by a publisher and a subscriber. The QoS policy consistency check module 420 determines whether the attribute values of the QoS policy set up by a publisher and a subscriber do not violate the attribute value of the QoS policy set up for a topic.

The QoS policy negotiation module 440 is responsible for the function of comparing the attribute values of QoS policies between remote locations in order to check whether the QoS policies satisfy compatibility for DDS communication and performing negotiations for QoS policies between remote locations. Here, negotiations for QoS policies between remote locations mean that a publisher and a subscriber check whether they can communicate with each other. A publisher and a subscriber exchange their QoS policies, and check whether the QoS policies have been set up so that communication is performed by comparing the QoS polices. If, as a result of the check, an unsuitable QoS policy exists, the publisher and the subscriber immediately stop a connection task for communication. Here, negotiation QoS policies negotiated by the QoS policy negotiation module 440 and characteristics for the negotiation QoS policies are listed in Table 2 below:

TABLE 2

| QoS Policies | Characteristics |
|---|---|
| Presentation | QoS for controlling data |
| Durability | QoS for durability of data |
| Deadline | QoS for checking validity of data |
| LatencyBudget | QoS for latency of data communication |
| Liveliness | QoS for providing notification that it is alive |
| Reliability | QoS for reliable/unreliable communication |
| DestinationOrder | QoS for arranging data in order |
| Ownership | QoS for representing ownership of data |

For example, in the case of the “Deadline” QoS policy, normal DDS communication can be performed when a deadline time provided by a publisher is longer than a deadline time desired by a subscriber. If the deadline time of the publisher is shorter than the deadline time of the subscriber, DDS communication between the publisher and the subscriber is not performed because the investigation of the publisher and the subscriber is not performed. Thus, the QoS policy negotiation module 440 determines whether QoS policies exchanged by the publisher and the subscriber are compatible with each other and thus DDS communication is possible by comparing and negotiating the QoS policies.

The QoS policy scheduling module 460 is responsible for the function of scheduling QoS policies. The QoS policy scheduling module 460 distributes the 22 types of QoS policies, provided by the DDS middleware, according to functions, such as data handling, resource allocation and traffic handling, and sets the order of priority for the QoS policies so that the QoS policy process module 500 handles the QoS policies from a QoS policy having the highest priority. The order of priority for the QoS policies is determined based on users who use the QoS policies. For example, if a user uses a policy for reliable data transmission, a traffic handling QoS policy related to actual data transmission is scheduled to have higher priority than a data handling QoS policy.

The QoS policy process module 500 is responsible for the function of processing the QoS policies of DDS.

More specifically, the data handling module 520 is responsible for the functions of QoS policies which process data in DDS, and is responsible for handling QoS policies using topic data used in DDS, such as “Partition” for partitioning data into logical groups and “Destination Order” for ordering received data.

The resource allocation module 540 is responsible for the function for handling QoS policies which process resources in DDS. The resource allocation module 540 is responsible for the function of handling QoS policies related to the resources of DDS middleware, such as “Resource Limits” for managing the resources of DDS and “History” for setting a method of maintaining DDS data

The traffic handling module 560 is responsible for the function for handling QoS policies associated with communication and a network. The traffic handling module 560 is responsible for the function of handling QoS policies necessary for DDS middleware to perform communication, such as “Deadline” for enabling real-time communication and “Liveliness” for providing notification that remote nodes are alive.

A method of supporting QoS in middleware for DDS according to the present invention will be described below.

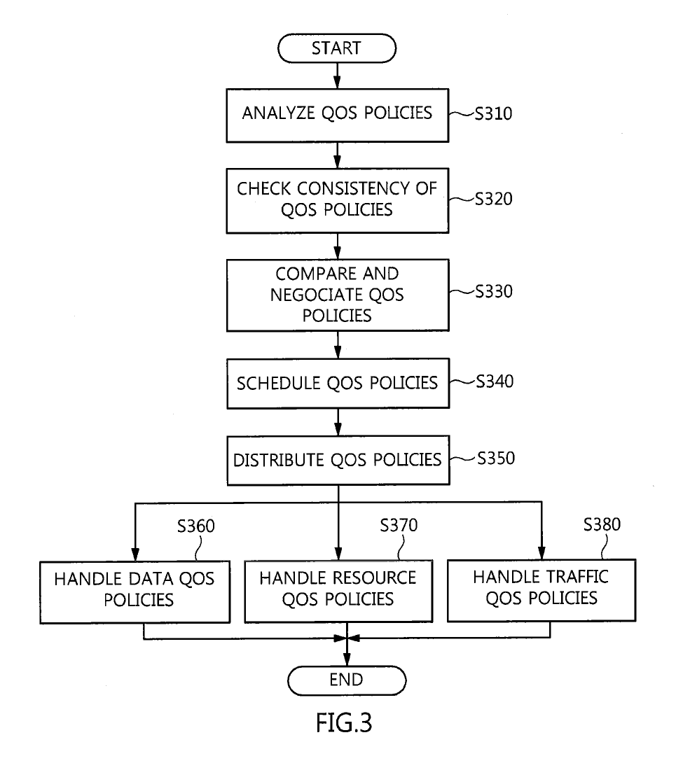

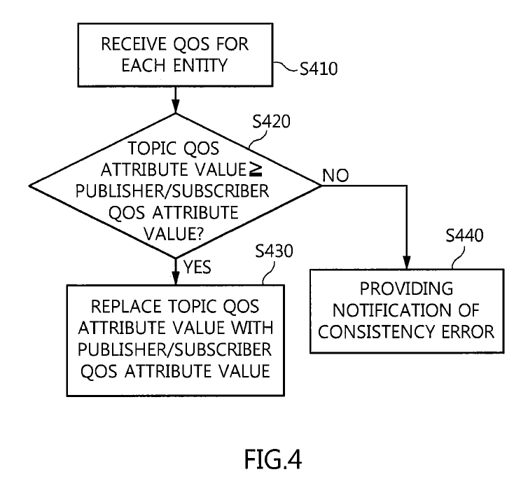

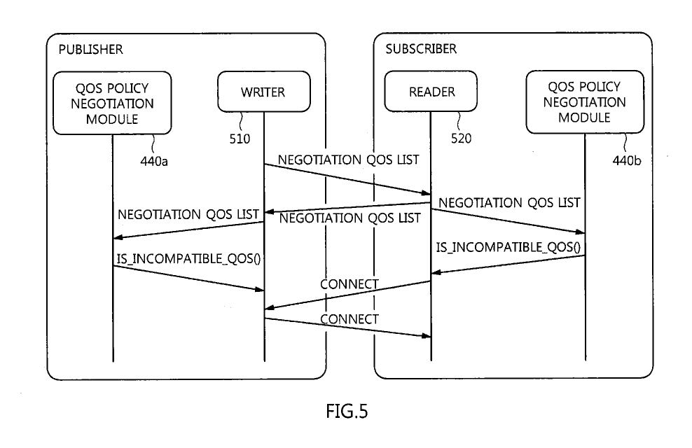

FIG. 3 is a flowchart illustrating the method of supporting QoS in middleware for DDS according to the present invention. FIG. 4 is a diagram schematically showing the process of checking the consistency of QoS policies in the method of supporting QoS in middleware for DDS according to the present invention. FIG. 5 is a diagram schematically showing a QoS policy negotiation procedure in the method of supporting QoS in middleware for DDS according to the present invention.

Referring to FIG. 3, in the method of supporting QoS in middleware for DDS according to the present invention, first, the QoS policy analysis module 300 reads a set of QoS policies related to publication and subscription set up by the DCPS 220 of an application program, and analyzes each of the QoS policies at step S310.

Thereafter, the QoS policy consistency check module 420 checks the consistency of QoS policies by determining the suitability of the attribute values of QoS policies set up by a publisher and a subscriber at step S320. Here, the QoS policy consistency check module 420 determines the consistency of the QoS policies by determining whether the attribute values of the QoS policies set up by the publisher and the subscriber do not violate the attribute value of a QoS policy set up for a topic.

In this regard, referring to FIG. 4, the QoS policy consistency check module 420 receives QoS policies for each entity at step S410. A QoS policy set up for a topic has higher priority than QoS policies set up by a publisher and a subscriber. Thus, the QoS policy consistency check module 420 determines whether the attribute value of the QoS policy set up for the topic is greater than or equal to the attribute values of the QoS policy set up by the publisher and the subscriber by comparing the attribute value of the QoS policy set up for the topic with the attribute value of the QoS policy set up by the publisher or the subscriber at step S420. If, as a result of the determination at step S420, it is determined that the attribute value of the QoS policy set up for the topic is greater than or equal to the attribute value of the QoS policy set up by the publisher or the subscriber, the QoS policy consistency check module 420 replaces the attribute value of the QoS policy set up for the topic with the attribute value of the QoS policy set up by the publisher or the subscriber at step S430. If, as a result of the determination at step S420, it is determined that the attribute value of the QoS policy set up for the topic is smaller than the attribute value of the QoS policy set up by the publisher or the subscriber, the QoS policy consistency check module 420 transfers a consistency error message to an application program so that the running of the application program is stopped at step S440.

After the step of checking consistency at step S320 has been performed, the QoS policy negotiation module 440 compares the attribute values of the QoS policies of the remote locations in order to check whether a QoS policy satisfies compatibility for DDS communication and then negotiates the QoS policies of the remote locations at step S330. Here, the comparison and negotiation of the QoS policy negotiation module 440 regarding the QoS policies of the remote locations are performed by comparing the QoS policies exchanged by the publisher and the subscriber at the remote locations and determining whether the QoS policies are compatible with each other and thus DDS communication is possible.

Referring to FIG. 5, the writer 510 of the publisher and the reader 520 of the subscriber at the remote locations exchange negotiation QoS policy lists, and then QoS policy negotiation modules 440a and 440b check whether the QoS policies of the publisher and the subscriber are suitable for communication based on step S330. If, as a result of the check, it is determined that the QoS policies are suitable for communication, the writer 510 of the publisher and the reader 520 of the subscriber perform a connection task for communication. If, as a result of the check, it is determined that a QoS policy unsuitable for communication is present, the writer 510 of the publisher and the reader 520 of the subscriber immediately stop the connection task for communication.

Thereafter, the QoS policy scheduling module 460 classifies the 22 types of QoS policies, provided by the DDS middleware, based on their functions, such as data handling, resource allocation and traffic handling, and schedules the QoS policies by setting the order of priority for the QoS policies at step S340 so that the QoS policy process module 500 may handle QoS policies from a QoS policy having high priority.

Thereafter, the QoS policy scheduling module 460 distributes the QoS policies, classified based on the functions, to the data handling module 520, the resource allocation module 540, and the traffic handling module 560 based on characteristics and the order of priority at step S350.

Thereafter, the data handling module 520 handles QoS policies for processing data in DDS at step S360. The resource allocation module 540 handles QoS policies for processing resources in DDS at step S370. The traffic handling module 560 handles QoS policies associated with the communication and the network of the DDS middleware at step S380. Here, steps S360 to S380 may be performed in parallel at the same time.

Meanwhile, the method of supporting QoS in middleware for DDS according to the present invention may be implemented in the form of program instructions which can be executed by various computer means and then recorded on a computer-readable recording medium. The computer-readable recording medium may include program instructions, data files, and data structures either solely or in combination. The program instructions recorded on the recording medium may be specially designed and configured for the present invention, or may be known to those having ordinary skill in the field of computer software.

The computer-readable recording medium includes a magnetic medium such as a hard disk, a floppy disk or a magnetic tape, an optical medium such as CD-ROM and a DVD, a magneto-optical medium such as a floptical disk, and a hardware device, such as ROM, RAM or flash memory which is specially configured to store and execute program instructions. Meanwhile, the recording medium may be a transmission medium such as an optical or metallic line or a waveguide, including a carrier for transmitting signals to indicate program instructions, a data structure, etc.

As described above, the apparatus and method for supporting QoS in middleware for DDS according to the present invention are not limited and applied to the constructions and methods of the embodiments described above, but all or some of the embodiments may be selectively combined and configured so that the embodiments may be modified in various ways.

As described above, the present invention may provide a framework for QoS which is capable of checking the consistency and compatibility of a set of QoS policies, grouping QoS policies having correlations, and handling QoS policies having higher priority first.

Furthermore, according to the present invention, the handling of the QoS policies of DDS may be classified into steps, and the QoS of middleware for DDS may be supported in order of the handling of the QoS policies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for supporting Quality of Service (QoS) in middleware for Data Distribution Service (DDS), the apparatus comprising:
a QoS policy analysis module for extracting a set of QoS policies set up by Data Centric Publish Subscribe (DCPS) and associated with publication/subscription, and analyzing the QoS policies;
a QoS policy management module for determining consistency of QoS policies of the DDS, and negotiating QoS policies for DDS communication; and
a QoS policy process module for handling the QoS policies of the DDS.

2. The apparatus as set forth in claim 1, wherein the QoS policy management module comprises a QoS policy consistency check module for determining the consistency of the QoS policies by determining suitability of QoS attribute values of the QoS policies set up by a publisher and a subscriber.

3. The apparatus as set forth in claim 1, wherein the QoS policy management module comprises a QoS policy negotiation module for comparing QoS attribute values of the QoS policies exchanged between a publisher and a subscriber, and performing negotiation so that the DDS communication is possible.

4. The apparatus as set forth in claim 1, wherein the QoS policy management module comprises a QoS policy scheduling module for distributing QoS policies provided by DDS middleware based on functions of data handling, resource allocation and traffic handling, and setting order of priority for the QoS policies.

5. The apparatus as set forth in claim 1, wherein the QoS policy process module comprises a data handling module for handling QoS policies related to data in the DDS.

6. The apparatus as set forth in claim 1, wherein the QoS policy process module comprises a resource allocation module for handling QoS policies related to resources in the DDS.

7. The apparatus as set forth in claim 1, wherein the QoS policy process module comprises a traffic handling module for handling QoS policies related to communication and a network in the DDS.

8. A method of supporting QoS in middleware for DDS, the method comprising:
by a QoS policy analysis module, extracting a set of QoS policies set up by DCPS and associated with publication/subscription, and analyzing the QoS policies;
by a QoS policy management module, determining consistency of the QoS policies of the DDS, and negotiating QoS policies for DDS communication; and
by a QoS policy process module, handling the QoS policies of the DDS.

9. The method as set forth in claim 8, wherein the determining consistency of the QoS policies of the DDS and the negotiating QoS policies comprises determining the consistency of the QoS policies by determining suitability of QoS attribute values of the QoS policies set up by a publisher and a subscriber.

10. The method as set forth in claim 8, wherein the determining consistency of the QoS policies of the DDS and the negotiating QoS policies comprises comparing QoS attribute values of the QoS policies exchanged between a publisher and a subscriber, and performing negotiation so that the DDS communication is possible.

11. The method as set forth in claim 8, wherein the determining consistency of the QoS policies of the DDS and the negotiating QoS policies comprises distributing the QoS policies provided by DDS middleware based on functions of data handling, resource allocation and traffic handling, and setting order of priority for the QoS policies.

12. The method as set forth in claim 8, wherein the handling the QoS policies of the DDS comprises handling QoS policies related to data in the DDS.

13. The method as set forth in claim 8, wherein the handling the QoS policies of the DDS comprises handling QoS policies related to resources in the DDS.

14. The method as set forth in claim 8, wherein the handling the QoS policies of the DDS comprises handling QoS policies related to communication and a network in the DDS.
